(19) United States
(12) Patent Application Publication
(10) Pub. No.: US 2006/0093095 A1
(43) Pub. Date: May 4, 2006

(54) Method and apparatus for test administration

(76) Inventors: Mathew W. Heck, Rolling Meadows, IL (US); Nancy Tippins, Greenville, SC (US); Ryan Bautista, Streamwood, IL (US); Theresa Csoka, Palatine, IL (US)

Correspondence Address: MCANDREWS HELD & MALLOY, LTD, 500 WEST MADISON STREET, SUITE 3400, CHICAGO, IL, 60661, US

(21) Appl. No.: 11/221,672

(22) Filed: Sep. 8, 2005

Related U.S. Application Data
(60) Provisional application No. 60/617,199, filed on Oct. 8, 2004.

(51) Int. Cl. H04M 3/22; H04M 1/24

(52) U.S. Cl. 379/21

(57) ABSTRACT

Certain embodiments of the present invention provide a system and method for improved, real-time test scheduling, administration, processing, and reporting. Certain embodiments of a test administration system for administering a test battery to a candidate include a test battery administration server for administrating a test battery to a candidate, a testing station facilitating a testing session for a user to take a test, and a security module for blocking unauthorized actions at the testing station during the testing session to preserve integrity of the test battery. The test battery administration server compiles a test battery including at least one test from a test library. The testing station receives the test battery from the test battery administration server. The testing station stores at least one response to the test battery and transmits at least one response to the test battery administration server.

### BACKGROUND OF THE INVENTION

The present invention generally relates to test administration. More specifically, the present invention relates to improved, real-time test scheduling, administration, processing, and reporting.

Many organizations value surveys, such as employee commitment surveys or multirater feedback surveys. Organizations use employee surveys to understand employee opinions and provide ongoing feedback on individual, team, and organizational performance. Organizations also use customer satisfaction surveys to gauge success of products or services and determine improvements. Managers may also be evaluated by employees using surveys.

Surveys may help initiate changes in a workplace environment, product or service improvements, and employee training, for example. Survey results may influence major strategic decisions by a corporation. Current survey systems do not provide a rapid response to help in making important, timely business decisions. Additionally, current survey systems are not easily accessible on demand.

Additionally, organizations use tests and assessments, such as competency or other qualification (knowledge-based or performance) tests to evaluate candidates for employment, promotion, reward, skill certification, etc. However, current testing systems require extensive administrator involvement resulting in a significant time commitment to administer tests to a group of people and may not support the full range of assessment types needed to have the most effective selection system (e.g., ability to include unique assessments like work samples). Both current handwritten and computerized tests involve significant set-up, monitoring, and scoring efforts by the test administrator and support personnel. Furthermore, current testing systems provide minimal security and leave an opportunity for a user to copy information from or interfere with a testing session. This is unacceptable because once test security is compromised, the test loses its usefulness and competitive advantage is lost.

Therefore, a system that provides real-time administration and processing of a test would be highly desirable. Additionally, a system that improves accessibility to tests, surveys, response data, and result statistics would be highly desirable. A test administration system that provides an uninterrupted secure test environment would be highly desirable. Thus, there is a need for a system and method for improved, real-time test administration and analysis.

### BRIEF SUMMARY OF THE INVENTION

Certain embodiments of the present invention provide a system and method for improved, real-time test scheduling, administration, processing, and reporting. Certain embodiments of a test administration system for administering a test battery to a candidate include a test battery administration server for administrating a test battery to a candidate, a testing station facilitating a testing session for a user to take a test, and a security module for blocking unauthorized actions at the testing station during the testing session to preserve integrity of the test battery. The test battery administration server compiles a test battery including at least one test from a test library. The testing station receives the test battery from the test battery administration server. The testing station stores at least one response to the test battery and transmits at least one response to the test battery administration server.

In an embodiment, the test battery administration server processes at least one response. In an embodiment, the test battery administration server generates feedback at the testing station based on at least one response. The test battery administration server may include a web service. The test battery administration server may include a plurality of privilege levels granting varying levels of access to administrators and users. The test battery administration server may generate a report based on the test battery and one or more responses. In an embodiment, the security module monitors testing and restricts activity, such as commands and functions, by a test taker.

Certain embodiments provide a method for secure test administration. The method includes compiling a test battery using at least one test from a test library and administering a test battery to a candidate. The method also includes storing at least one response to the test battery for a testing session at a testing station and transmitting the at least one response to the test battery to a test administration server. Further, the method includes blocking unauthorized actions at the testing station during the testing session to preserve integrity of the test battery and the at least one response.

The method may also include processing one or more responses. Additionally, the method may include generating feedback based on the response(s). In an embodiment, a report may be generated based on the test battery and one or more responses, for example. In an embodiment, a privilege level may be set to grant a certain level of access to the test battery and/or test response(s). In an embodiment, the method includes intercepting key strokes and commands to restrict activities of a test taker. The method may also include encrypting the test battery and/or the test response(s).

Certain embodiments provide a method for network test administration. The method includes downloading a testing application to a testing station, constructing a test battery for a candidate, decrypting the test battery for the candidate at the testing station, encrypting responses to the test battery for the candidate, and transmitting the encrypted responses to a testing server. In an embodiment, the encrypted responses may be decrypted and stored, for example. Multi-rater feedback and/or other feedback may be provided based on the responses. In an embodiment, the method further includes examining the testing station for test response files and uploading test response files to the testing server. The testing station may be monitored to intercept execution of a command or function not allowed for the test battery. In an embodiment, rules may be defined to protect test content in the test battery and responses.

### BRIEF DESCRIPTION OF SEVERAL VIEWS OF THE DRAWINGS

FIG. 1 illustrates a web-based testing system for administering tests via a network used in accordance with an embodiment of the present invention.

FIG. 2 illustrates a flow diagram for network test administration used in accordance with an embodiment of the present invention.

FIG. 3 shows an example of exchange of data in a web-based testing system used in accordance with an embodiment of the present invention.

FIG. 4 shows an example of exchange of data in a web-based testing system used in accordance with an embodiment of the present invention.

FIG. 5 shows an example of exchange of data in a web-based testing system used in accordance with an embodiment of the present invention.

FIG. 6 shows an exemplary feedback report used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

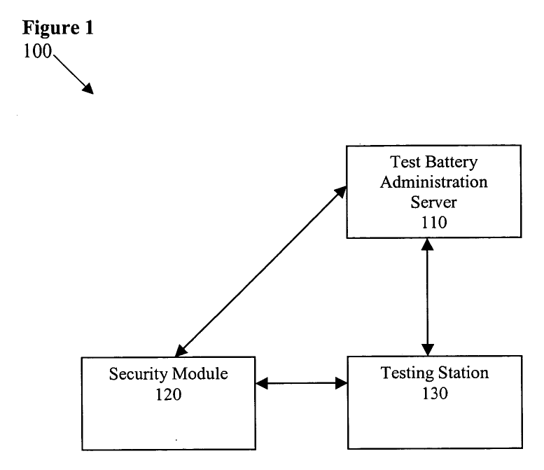

FIG. 1 illustrates a web-based testing system 100 for administering tests via a network used in accordance with an embodiment of the present invention. The system 100 includes a test battery administration server 110, a security module 120, and a testing station 130. Functionality may be divided between testing application executable running on the testing station 130, the security module 120, and/or the battery server 110. For purposes of illustration only, certain exemplary embodiments are described.

The testing system 100 provides a platform by which organizations may administer tests to current and/or prospective employees for promotion, selection, reward, certification, etc. The system 100 may administer test(s) to an individual and/or to a group, for example. The system 100 may administer the same test and/or different tests to individuals in a group. The system 100 may also be used to administer surveys, reviews, and/or other feedback questionnaires to individuals and/or groups. Certain embodiments provide a tiered testing system allowing multiple test administrators. Certain embodiments provide task scheduling capability for users and/or administrators to schedule tests or other reviews.

The test battery administration server 110 facilitates test administration and processing for participating organizations. The server 110 may be hosted by a provider for access by participating organization(s) and/or may be hosted by a specific organization for that organization's testing, for example. The server 110 is a hardware platform running software, such as an operating system, test compilation software, and test processing software, to facilitate test administration and results processing. The server 110 may be a single unit or may be divided into multiple hardware and/or software subsystems for testing administration, processing and storage.

The server 110 provides the testing station 130 with a testing application executable to administer a test battery at the testing station 130. The server 110 assembles a battery of test(s) and/or test question(s) from a library. The server 110 encrypts the battery for transmission to the testing station 130. The server 110 receives a candidate's test responses from the testing station 130 and encrypts and stores the responses in a database or other data storage structure. The server 110 may receive responses from the station 130 continuously, at regular intervals, and/or upon completion of an individual test or test battery, for example. The server 110 may include software to process test results and generate an outcome and/or a report for a candidate, an organization, and/or a test battery, for example. The server 110 may generate one or more reports of various types depending upon system configuration, test battery, and/or user selection, for example.

The security module 120 provides security for the testing platform, testing session, and/or testing environment, for example. The security module 120 minimizes disruptions in the test environment on the testing station 130. The security module 120 runs on the testing station 130 and/or the server 110 and may be a standalone or integrated software and/or hardware system.

The security module 120 intercepts key strokes and other commands and prevents a user or other program from executing a command or function that is not allowed by the test configuration. The security module 120 may work with the testing application and/or the operating system or other software on the testing station 130 to block unapproved actions occurring at the testing station 130. The security module 120 may monitor testing and restrict a test taker's activities. The security module 120 minimizes what a user may do to copy or print test content, for example. The security model 120 also prevents test takers from accessing other programs, files, websites, etc. that would allow them to secure answers to tests to enhance their scores. In an embodiment, a program or administrator may define and/or select rules to protect test content using the website or other program, for example. Rules may be selected from a library, modified, and/or created.

In an embodiment, the security module 120 tracks tests across different sessions. For example, a candidate took Test 1 to apply for Job A and is now applying for Job B. The security module 120 works with the server 110 to provide the candidate with a different test.

The testing station 130 is a hardware platform running software, such as an operating system and a testing application executable to facilitate a testing session. The station 130 may be a single unit or may be divided into multiple hardware and/or software subsystems. The testing station 130 runs the testing application executable from the server 110 to prepare the testing station 130 and administer a battery of test(s) to a candidate. The testing application may track a condition, such as a time limit, a number of incorrect answers, completion of the test, or other condition, and may end the testing session based on fulfillment of the condition. Alternatively, the application may modify the content of the test based on the condition. The testing station 130 communicates with the server 110 to transfer the testing application, a test battery file, test responses, and/or a feedback report, for example. The testing station 130 stores test battery and/or response information locally so that the testing session is not dependent on a network connection. In an embodiment, the testing station 130 saves response and/or other status information to the server 110 continuously, at a certain interval, and/or upon completion of a test and/or test battery, for example.

In certain embodiments, the system 100 allows administrator(s) to set privilege levels for a test and/or testing platform, for example. An administrator or system operator may establish different levels of access and control for different users, groups of users, and/or tests, for example. Custom controls may be tailored for each administration or access level. An owner may control who accesses the system 100, what each user may do within the system, and what data a user is allowed to view, for example. Access may be controlled through a hierarchy that determines how test sessions, scores, and/or reports are maintained, for example. Access to data and functions in the system 100 may be restricted through hierarchy levels and paths and/or through specific permissions assigned to each user or group of users, for example. A hierarchy may be based on organization structure and/or other criteria, for example. In an embodiment, a user with permission at a given hierarchy level may view information at or below the hierarchy level but not above the hierarchy level. Permissions may be divided into activity sets, such as test management, scheduling, reporting, and/or hierarchy, for example. A user and/or group of users may be given all permissions within one or more activity set(s) or any subset of permissions.

Test management permissions may include administer tests only (e.g., the user may administer a test battery but not access account administration screens), administer and monitor tests (e.g., the user is able to administer a test, monitor a test session, and view candidate details), pause and restart tests (e.g., the user may pause and restart the administration of a candidate or group of candidates in times of emergency, such as a fire alarm), enter individual test data (e.g., the user may enter test data into the system for a candidate who took a test on paper), mark a test record as invalid (e.g., the user is allowed to mark an individual candidate's score as invalid for a particular test session), approve and/or make time accommodations (e.g., the user is allowed to change the time allotted for a specific test due to an approved accommodations request and may also approve of other non-time related accommodations), and/or schedule/reschedule/cancel candidates (e.g., the user may schedule, reschedule, and cancel a candidate from a testing session), for example.

Scheduling permissions may include override form assignment (e.g., the user is allowed to change the form assigned by the system if there are multiple versions/forms of the same test), schedule/reschedule/cancel candidates, waive the administration of a test (e.g., the user may waive a candidate from taking a particular test), approve and/or make time accommodations, create and maintain test sessions (e.g., the user may create and maintain a testing session, such as session date, time, number of slots, etc.), create and maintain test locations (e.g., the user may create a new testing location within the system as well as modify information regarding a location), view candidate history onscreen without scores (e.g., the user may view a candidate's previous testing information such as test session, test battery assigned, etc.), view candidate history onscreen including scores (e.g., the user may view a candidate's previous testing information and also view the scores), and/or change candidate name and ID after testing begins (e.g., the user may modify a candidate's name and identification regardless of whether the candidate has begun testing or not), for example.

Permissions for reporting may include adverse impact report (e.g., the user may view an adverse impact report) and/or candidate results report (e.g., the user may view a candidate results report), for example.

In an embodiment, different test versions and/or questions may be included and/or excluded from a test battery. One or more test batteries may be associated with one or more job categories. Test batteries may include tests assessing aptitude, personality, and/or qualification in a certain area, for example. For example, tests may include arithmetic tests, reading tests, checking or comparison tests (e.g., testing the ability to compare information quickly and identify similarities and differences), situational judgment inventory (e.g., measure behaviors such as interpersonal skills, sales skills, and/or customer service skills for a job), and/or a work orientation questionnaire (e.g., measure characteristics such as interpersonal skills and service skills for a job), for example.

In an embodiment, test sessions and/or other tasks may be scheduled in advance at the server 110. Scheduling allows a candidate to be set up in the system 100 for testing. Scheduling may include the candidate's contact information (e.g., name, address, phone number, email address, identification number, candidate type, job family, job title, battery, etc.), testing session information (e.g., location, date, start time, duration, etc.), test battery information (e.g., how many tests, how many questions, which battery, which tests, etc.), and/or a position, reward, etc. for which the candidate is applying. Accommodation requests (e.g., time accommodation, location accommodation, etc.) and/or candidate testing history (e.g., information regarding prior tests taken, job applied for, test results, etc.) may also be noted in the schedule. An administrator may select from a list of options, modify existing options, and/or create new options in scheduling or setting other parameters, for example. An administrator with proper permissions may monitor a testing session, pause a candidate's test, reschedule a task, make accommodations, and/or perform other tasks, for example, via the system 100.

In operation, information for a testing session is rendered into an encrypted form at the server 110. Encrypted information may be stored at the server 110 in a database, memory, and/or other data structure, for example. The encrypted information is sent to the testing station 130 for a testing session. A testing application running on the testing station 130 reads the encrypted testing information. The application displays one page of the testing information at a time on the testing station 130 display. The user interfaces with the testing station 130 through a keyboard, mousing device, touch screen, or other interface to take the test. The security module 120 helps to ensure that the user does not copy or interfere with test contents or the testing station 130. Test results are stored locally at the testing station 130 and transferred to the server 110. The server 110 may then generate a reporting of test results which may be stored, displayed at the testing station 130, and/or displayed to an administrator, for example.

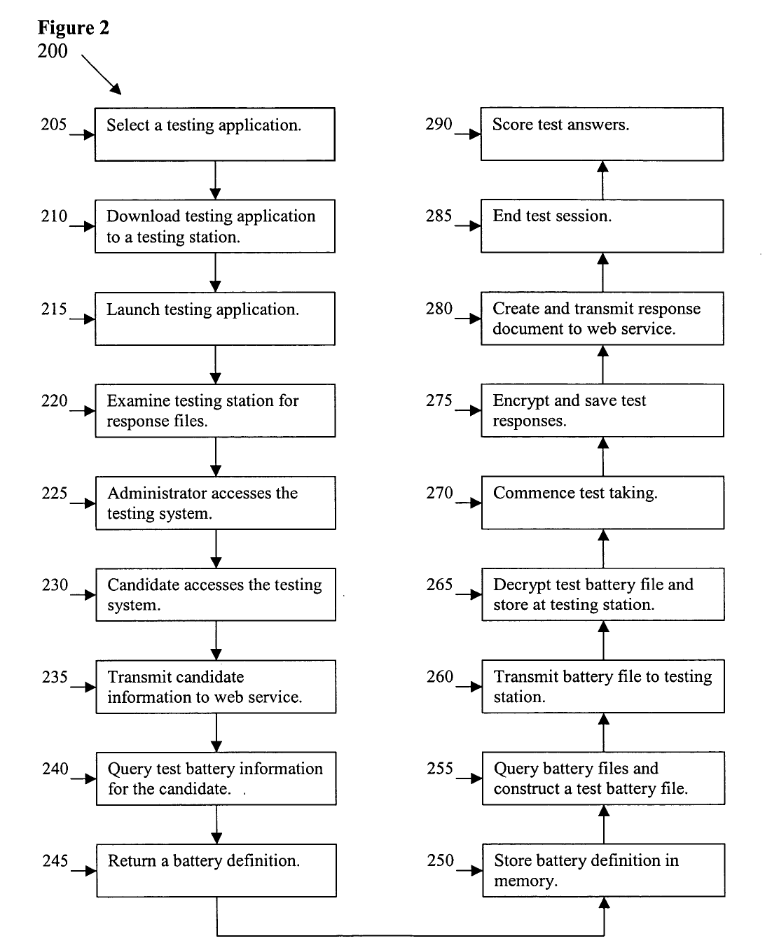

FIG. 2 illustrates a flow diagram 200 for network test administration used in accordance with an embodiment of the present invention. First, at step 205, an application executable is selected by an operator or software program. Selection may be performed manually, automatically, and/or with assistance from a menu or decision-making system, for example (e.g., the system may offer an application version with client specific format or branding based on administrator login).

Then, at step 210, the application executable is downloaded to a testing station. The executable may be downloaded via the Internet, such as via the World Wide Web, a local area network, a wide area network, a private network, and/or a dedicated connection, for example. Next, at step 215, the application executable is launched. The application may be launched locally or remotely by an operator, user, and/or software program, for example. At step 220, once the application is launched, the testing station is examined to determine if any response files reside on the station. For example, response files including responses from a previous testing session may be stored locally at the testing station. If response file(s) or other testing files are stored at the testing station, then the files may be uploaded to a server, such as a battery cache web server, for storage. For example, a response file is uploaded to the battery cache web service and saved as a final response to a test.

Next, at step 225, a test administrator “logs in” or accesses the testing system. The test administrator may adjust certain settings or options for the testing session if allowed by the testing system and not prohibited by any privileges or rules set for the system. The administrator(s) may access the testing system via a testing station, web site, or workstation, for example. In an embodiment, the administrator or other authorized operator may access the testing system before, during and/or after the testing session to monitor test information, station status, candidate information, and/or other status information, for example. Then, at step 230, the candidate logs in or accesses the testing station.

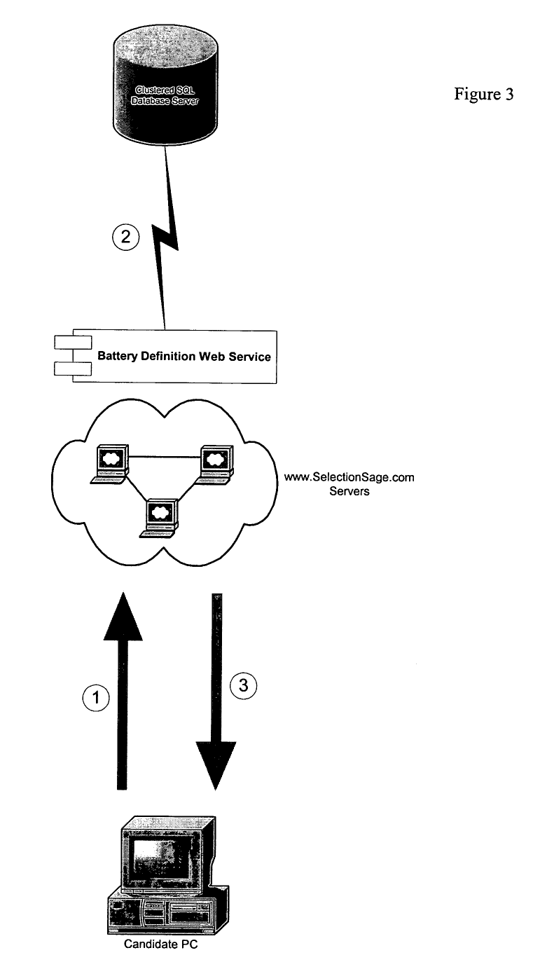

Next, a test battery is defined. At step 235, candidate information is transmitted to a battery definition web service. Then, at step 240, the battery definition web service queries test battery information for a candidate in a testing session. The service then constructs an XML (Extensible Markup Language) definition or other display and input format for the testing session. At step 245, the web service returns a battery definition, such as an XML battery definition, describing the test(s) the candidate will be taking in the testing session. Then, at step 250, the application executable stores the battery definition in memory. An example of transmission of candidate information and return of a battery definition is shown in FIG. 3.

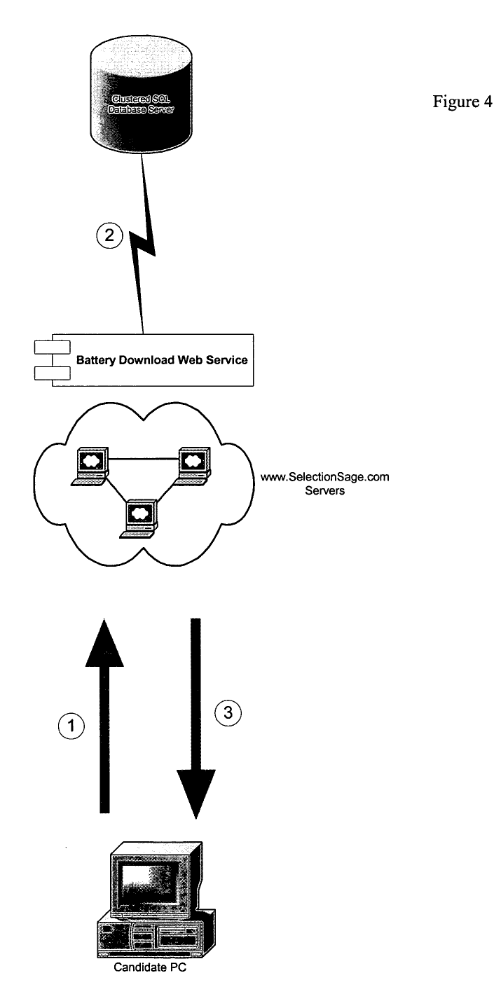

Next, at step 255, the web service queries battery files to be included in the test battery download and constructs a test battery file. In an embodiment, the test battery file is constructed as an encrypted, compressed file, such as an encrypted zip file. Then, at step 260, the web service transmits the encrypted file containing files to take the test battery to the testing station. At step 27065, the application decrypts the battery file at the testing station, encrypts each individual file, and stores the files locally at the testing station. An example of downloading a test battery to a testing station from a web service is shown in FIG. 4.

At step 270, test taking commences. The candidate begins answering questions and/or performing tasks according to the battery of tests stored at the testing station. In an embodiment, the candidate may be provided with navigation aids to navigate through the test battery, instructions for the test battery, status information, and other test-taking aids, for example.

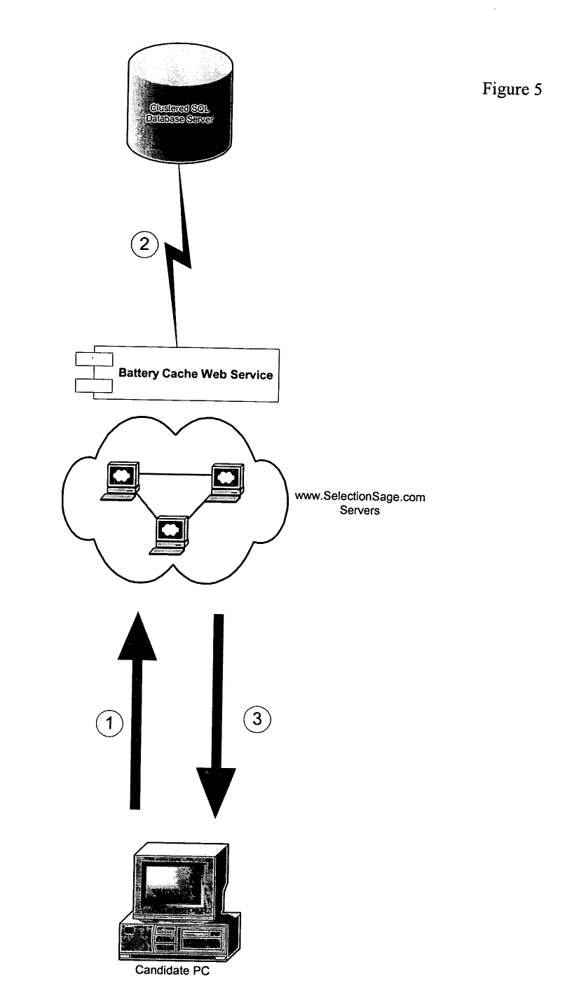

Then, at step 275, responses to the test battery are encrypted and saved at the testing station. Next, at step 280, a document, such as an XML document, is created including all item responses to the test and is transmitted to a battery cache web service. The web service stores responses for a candidate and test. Responses for a candidate for a test may be stored in a cache at the web service. Individual responses by the candidate for the test may be stored in a response table. Once all questions have been answered and the test completed, the test may be marked complete in the response table. In an embodiment, the web service returns a response to the application at the test station indicating whether or not the save was successful. Alternatively or in addition, the web service may transmit a status message to an external server or an administrator. If the test administrator pauses, restarts and/or ends the battery, a message indicating test status is transmitted rather than a success message. In an embodiment, test responses are saved locally and transferred to the battery cache web service continuously and/or at certain intervals. An example of transferring test response information to a battery cache web service is shown in FIG. 5.

At step 285, after the battery of tests has been completed by the candidate or a triggering event occurs, the test session ends. The triggering event may be a timer/time limit, a number of wrong answers, or other limiting event, for example. In an embodiment, the triggering event may also be a system event, such as a shutdown of the testing station, and/or a software or hardware error.

At step 290, the test answers are scored. Test results may include test form, test sub-form, and battery level scores. Test item, raw scores, standardized scores, and interpreted scores may be calculated. In an embodiment, to protect test confidentiality and ensure integrity of test scores, all values used to calculate scores are stored in a binary format. The binary format serves as a permanent record of the test event only retrievable through the application. In an embodiment, test answers may be scored prior to the end of the test session, and feedback may be provided to the candidate and/or an administrator prior to the end of the test session.

After the testing battery has been completed and/or on system shutdown, the application executable deletes test files (e.g., encrypted test files) used to present the test battery to the candidate on the testing station. Before shutting down, the application determines whether any response files (e.g., encrypted response files) are present at the testing station. If response files are found, the application alerts the administrator/user to the presence of the response files. The user may then wait to exit/shut down the testing station to allow the responses to be transmitted to the web server. If the user waits, the application may run in the background to transfer the file. Alternatively, the user may continue to shut down the station or exit the testing application, and the response files will be transferred upon the next execution of the testing application.

During test administration, the testing application executable monitors the testing station to ensure that the testing application is the active window on the station desktop. If the application is not the active window on the station desktop, the application sets itself to be the active window so that the testing window will be “on top” and foremost on the testing station display. The application executable also clears the memory in the system clipboard to help ensure that no files or test questions are copied from the testing session. Additionally, short cut key strokes and other commands may be captured to prevent the test(s) from being compromised (e.g., print screen, copy, CTRL-P, CTRL-C, etc.).

If the network connection between the testing station and the battery server(s) were to be disconnected or dropped during a test, the candidate will be able to continue to take the entire battery uninterrupted. If the candidate is taking the battery and the connection is dropped, the testing application executable checks continuously or at certain intervals during the battery to determine if the Internet connection has been restored. Response data is saved locally. Once the connection has been restored, the application sends all response files to the cache server.

If the testing station were to crash or experience an error resulting in lock-up or shut-down of the machine, the encrypted response(s) to the test(s) still reside on the testing station. Once the testing station has been restarted or operation of the station has been otherwise resumed and the candidate logs back on, the application starts the candidate where he or she stopped based upon the locally stored response(s). If the testing station is unrecoverable, the candidate may finish the test battery from another testing station, and the application will have the candidate resume testing after the last successfully uploaded response.

In an embodiment, a feedback page may be displayed at the end of a test battery. A check is done to ensure that all test(s) have been completed for the candidate. If the test(s) are complete, a scoring component scores the candidate's battery based upon standard formulas, client-specific formulas, or other formulas. Then, feedback regarding test results is provided to the candidate and/or administrator. The feedback page may also allow the candidate and/or administrator to provide feedback regarding the test battery, testing process, and/or test conditions, for example.

In an embodiment, the survey system works in conjunction with a survey processing system. An example of a real-time, electronic survey processing and reporting system is described in U.S. patent application Ser. No. 10/844,067, entitled “Method and Apparatus for Survey Processing”, by William Macey et al., filed on May 11, 2004, which is herein incorporated by reference in its entirety.

As an example, a test battery may be processed and scored to determine if an applicant is qualified for a position with a company. In an embodiment, a plurality of information is processed and stored to determine a candidate's qualification based on battery results. Information stored may include test item responses, test item scores (e.g., 1=correct, 0=incorrect, based on a scoring key), scaled raw scores (e.g., a number of correct responses minus ⅓ of a number of incorrect responses), scaled standardized scores, scaled interpreted scores, raw battery scores, individual battery standardized scores, individual batter interpreted scores, job family raw battery score (e.g., if combining two individual battery scores), job family battery standardized score, job family battery interpreted score, and/or other information already determined (e.g., name, identifier, sex, race, demos, etc.).

Scaled standardized scores, for example, may be computed using a table of test means and standard deviations. Scaled standardized scores may be computed as follows:
(raw score−mean)/standard deviation (1)
Scaled standardized scores may also be referred to as arithmetic standardized score or WO-A standardized scores, for example.

Individual raw and/or standardized battery scores may include a plurality of numbers. Individual battery scores may include “Cognitive Battery Score,” “Non-Cognitive Battery Score,” and/or “Standardized Cognitive Battery Score,” for example. Different formulas may be used to compute individual battery scores and standardized individual battery scores. Formulas used may be different for each organization and/or user.

Job family raw and/or standardized battery scores may be computed using a single formula to determine a job family battery score and/or a standardized job family battery score. The formula(s) may be standard formulas and/or may vary by organization and/or user, for example.

Once standardized scale scores and applicable battery scores have been computed, a determination is made regarding the qualification of the applicant. The applicant may qualify based on job family battery score, a multiple hurdles approach, a multiple qualifications approach, and/or a compensatory approach, for example. Using a job family battery score, for example, a determination is made regarding whether the job family battery score for each participant falls above a cutoff score provided for the battery.

Under a multiple hurdles approach, standardized scale scores, individual battery scores, and/or job family battery scores may be used to determine applicant qualification. For example, in order to pass, an applicant may have a standardized arithmetic score above 5, a standardized situational judgment inventory (SJI) score above 3, a non-cognitive individual battery score above 4, and a job family battery score above 2. Scores and information used may vary based on organization, user, and/or reward, for example.

With a multiple qualifications approach, a single test administration may be used to qualify applicants for multiple levels or positions. For example, a job family battery score of 15 may be required for some sales jobs, while a score of 10 may qualify an applicant for some lower level sales jobs, and a score of 2 may quality an applicant for a customer service job. More complicated multiple qualifications may also use the multiple hurdles approach to incorporate more than one set of requirements, one for higher level jobs and one for lower level jobs, for example.

In an embodiment, a compensatory approach may be used in which one or more higher scores for some individual tests may “compensate” for lower scores on other tests. Thus, a candidate reaches a particular cutoff on some combination of tests rather than on all tests. For example, a minimum score of at least 4 may be required on any three of five tests. More complex schemes may require a score of 4 on either arithmetic or word problems, for example. An even more complex scheme involves a score of 4 on arithmetic or word problems or, if a score on either arithmetic or word problems is below 3, then the score on the other test must be 5 or higher. A compensatory approach may be combined with any of the other methods.

In an embodiment, an administrator and/or organization desires to provide individual feedback to participants regarding their performance on scores such as the job family battery score, standardized battery scores, standardized individual scores, and/or other scores. Feedback may be provided in a format such as Table 1 below. Table 1 indicates what feedback text is associated with each score range. For example, if a person scored below 3 on a reading test, then the person would have a feedback of “low” for the test.

TABLE 1

| | Low | Medium | High |
|---|---|---|---|
| Test | Performance | Performance | Performance |
| Reading | Below 3 | 3-6 | above 6 |
| Arithmetic | Below 4 | 4-6 | above 6 |
| SJI | Below 2 | 2-4 | above 4 |
| Work Orientation - | Below 2 | 2-4 | above 4 |
| Conscientiousness | | | |
| Work Orientation - | Below 2.5 | 2.5-4 | above 4 |
| Agreeableness | | | |
| Cognitive Battery | Below 3 | 3-7 | above 7 |
| Non-Cognitive Battery | Below 5 | 5-10 | above 10 |
| Super Battery | Below 7 | 7-12 | above 12 |

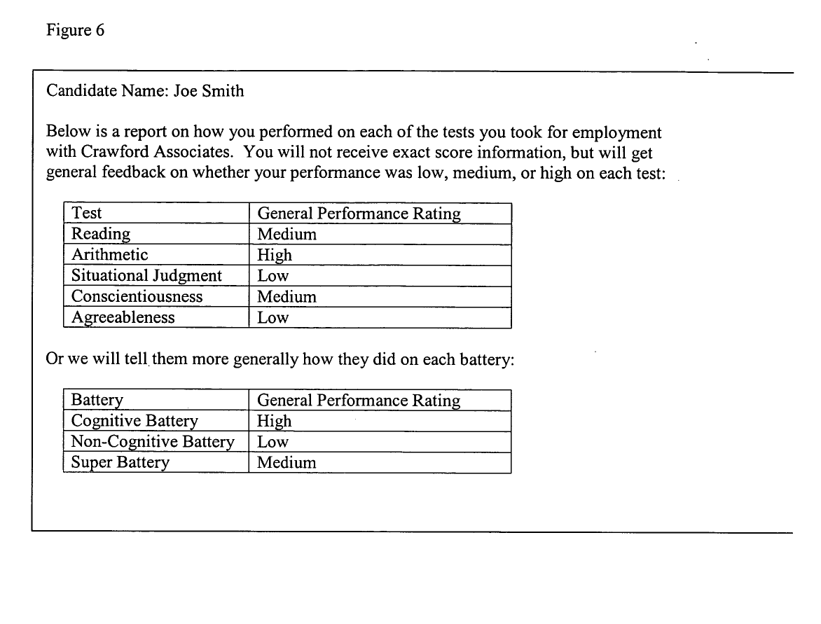

Table 1 may be used to generate a feedback report for a participant such as the report shown in FIG. 6. The feedback report shown in FIG. 6 is based on the following hypothetical set of scores: Reading=3, Arithmetic=7, Situational Judgment=1, Conscientiousness=3, Agreeableness=2, Cognitive Battery=8, Non-Cognitive Battery=4, and Super Battery=8.

Response data, scoring data and/or candidate data may be used to generate a variety of individual and/or group reports. Reports may include, for example, a candidate results report and/or an adverse impact report. A candidate results report provides information about a particular candidate or group of candidates. With the report, an administrator may specify filtering criteria to apply. For example, the report may be used to determine whether or not a candidate is qualified for a position as well as to obtain a list of all qualified candidates for a particular job title in a particular location. An adverse impact report provides information about pass rates for a protected group of candidates (e.g., women, Hispanics, African Americans, etc.) compared with another group (e.g., men, Caucasians, etc.). The report may be used by an organization to track whether or not protected groups and non-protected groups are passing tests at relatively comparable rates, for example.

Thus, certain embodiments provide a secure, state-of-the-art web-based testing platform for assessing job candidates, selecting employees for promotion, and/or delivering certification tests, for example. Certain embodiments include powerful reporting capabilities provide fast results with easy-to-use data reports, including adverse impact reports, for example. Certain embodiments provide a decentralized administration structure which allows a user to create a system tailored for the unique complexities of the user's organization. Certain embodiments of the test administration system are available as a hosted application directly to clients or through authorized distributors. Alternatively, the administration system may be run as a standalone application or in a private network, for example.

In an embodiment, the testing system 100 may be used in conjunction with a multi-rater or 360-degree feedback system. The multi-rater feedback system may include survey creation, rater nomination and approval, deployment over a network such as the Internet or a dedicated network, and reporting. The multi-rater system may include normal data for benchmarking of results. The multi-rater system may provide a variety of reports such as standard group or individual reports, individual or group norm reports, and/or custom reports. Normative groups may be selected for reporting multi-rater feedback. In an embodiment, norms may be altered to make the norms and results more meaningful for a particular user or group.

The multi-rater system may support major world languages to enable global deployment. Surveys are translated into a plurality of languages. An owner or administrator may select language(s) in which to release survey(s). A user being surveyed may then see the offered languages and select a language in which to take the survey. The multi-rater system accommodates results submitted in any of the provided languages. The system correlates results from the provided languages for reporting. In an embodiment, the multi-rater system allows the selected language to be changed mid-survey and still maintain the response data.

The multi-rater system may be a tiered system allowing varying levels of access to different users. The tiered administration method may be similar to the tiered administration method of the test administration system, for example. In an embodiment, overall settings are made by an owner. The owner may delegate certain permissions to other administrators, for example.

Administrative features may be role-dependent. A system owner may set restrictions that limit the scope of what administrators may or may not be able to change or configure. The owner determines whether properties, such as timeline, supervisory approval of raters, etc., are fixed or if an administrator has authority to change a property/parameter for his or her group. In an embodiment, the system is scalable to accommodate complex organizations. The system may allow scheduling and automation. Multi-rater feedback may proceed without external consultant intervention. Multi-rater feedback may be customized for an organization's issues. Multi-rater feedback may be used with action planning to raise individual and/or organizational performance.

In an embodiment the testing system 100 and other systems may be hosted via an application service provider (ASP) platform. The ASP hosts and manages the application(s) and allows users to access services via a network (e.g., via the Internet through a web browser). Content such as surveys, multi-rater feedback, and/or tests may be quickly and easily delivered using the ASP. Using an ASP allows participating organizations to save money that would be used to fund, build and maintain a network infrastructure for the testing system 100 and other services. Automatic or manual software upgrades may be transparent to users of the system 100 via the ASP.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A test administration system for administering a test battery to a candidate, said system comprising:
a test battery administration server for administrating a test battery to a candidate, wherein said test battery administration server compiles a test battery including at least one test from a test library;
a testing station facilitating a testing session for a user to take a test, wherein said testing station receives said test battery from said test battery administration server, said testing station storing at least one response to said test battery and transmitting said at least one response to said test battery administration server; and
a security module for blocking unauthorized actions at said testing station during said testing session to preserve integrity of said test battery and said at least one response.

2. The system of claim 1, wherein said test battery administration server processes said at least one response.

3. The system of claim 1, wherein said test battery administration server generates feedback at said testing station based on said at least one response.

4. The system of claim 1, wherein said test battery administration server comprises a web service.

5. The system of claim 1, wherein said test battery administration server includes a plurality of privilege levels granting varying levels of access to administrators and users.

6. The system of claim 1, wherein said test battery administration server generates a report based on said test battery and said at least one response.

7. The system of claim 1, wherein said security module monitors testing and restricts activity by a test taker.

8. A method for secure test administration, said method comprising:
compiling a test battery using at least one test from a test library;
administering a test battery to a candidate;
storing at least one response to said test battery for a testing session at a testing station;
transmitting said at least one response to said test battery to a test administration server; and
blocking unauthorized actions at said testing station during said testing session to preserve integrity of said test battery and said at least one response.

9. The method of claim 8, further comprising processing said at least one response.

10. The method of claim 8, further comprising generating feedback based on said at least one response.

11. The method of claim 8, further comprising generating a report based on said test battery and said at least one response.

12. The method of claim 8, further comprising setting a privilege level granting a level of access to at least one of said test battery and said at least one response.

13. The method of claim 8, further comprising intercepting key strokes and commands to restrict activities of a test taker.

14. The method of claim 8, further comprising encrypting at least one of said test battery and said at least one response.

15. A method for network test administration, said method comprising:
downloading a testing application to a testing station;
constructing a test battery for a candidate;
decrypting said test battery for said candidate at said testing station;
encrypting responses to said test battery for said candidate; and
transmitting said encrypted responses to a testing server.

16. The method of claim 15, further comprising decrypting and scoring said encrypted responses.

17. The method of claim 15, further comprising providing multi-rater feedback based on said responses.

18. The method of claim 15, further comprising:
examining said testing station for test response files; and
uploading test response files to said testing server.

19. The method of claim 15, further comprising monitoring said testing station to intercept execution of a command or function not allowed for said test battery.

20. The method of claim 15, further comprising defining rules to protect test content in said test battery and said responses.
